(19) United States
(12) Patent Application Publication
(10) Pub. No.: US 2025/0100847 A1
(43) Pub. Date: Mar. 27, 2025

(54) METHOD FOR DETECTING AT LEAST ONE LITTER OBJECT INSIDE AN ELEVATOR CAR AND AN ELEVATOR CAR LITTER DETECTION SYSTEM

(71) Applicant: KONE Corporation, Helsinki (FI)

(72) Inventors: Zuhair ul HAQ, Helsinki (FI); Mari ZAKRZEWSKI, Helsinki (FI); Otto PEKANDER, Helsinki (FI)

(73) Assignee: KONE Corporation, Helsinki (FI)

(21) Appl. No.: 18/973,746

(22) Filed: Dec. 9, 2024

Related U.S. Application Data
(63) Continuation of application No. PCT/FI2022/050506, filed on Jul. 27, 2022.

(51) Int. Cl. B66B 5/00

(52) U.S. Cl. CPC B66B 5/0006; B66B 5/0087

(57) ABSTRACT

A method for detecting at least one litter object inside an elevator car includes obtaining optical image data of the interior of the elevator car; detecting one or more objects from the optical image data; and classifying the detected one or more objects into predefined object categories based on predefined litter object definition data, the predefined object categories including a litter object category and at least one other object category; detecting at least one litter object, if at least one of the detected one or more objects is classified in the litter object category; and generating a control signal to an elevator processing system for generating a service need request in response to detecting the at least one litter object. An elevator car litter detection system and an elevator system are disclosed.

### TECHNICAL FIELD

The invention concerns in general the technical field of elevators. Especially the invention concerns monitoring cleanness of elevator cars.

### BACKGROUND

Typically, hygiene condition and cleanness of an elevator car plays a decisive role in a ride comfort of passengers of the elevator car. Customers may often require the elevator cars to remain clean during their operational hours. For example, hotels may require strict cleanness of the elevator cars to provide a good experience to their customers. Typically, the owner of the building is responsible for maintaining good hygiene condition and cleanness in the elevator cars. For this purpose, for example a sanitation inspector may be required to go to the site (i.e. the elevator car) for making sanitary checks, and if the elevator car is dirty, the sanitation inspector may call cleaning services to clean the elevator car. Alternatively or in addition, the cleaning of the elevator car may be scheduled.

Therefore, the is a need to further develop solutions for monitoring cleanness of the elevator cars.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, an elevator car litter detection system, and an elevator system for detecting at least one litter object inside an elevator car. Another objective of the invention is that the method, the elevator car litter detection system, and the elevator system for detecting at least one litter object inside an elevator car improve monitoring cleanness of elevator cars.

The objectives of the invention are reached by a method, an apparatus and a computer program as defined by the respective independent claims.

According to a first aspect, a method for detecting at least one litter object inside an elevator car is provided, wherein the method comprises: obtaining optical image data of the interior of the elevator car; detecting one or more objects from the optical image data; classifying the detected one or more objects into predefined object categories based on predefined litter object definition data, wherein the predefined object categories comprise a litter object category and at least one other object category; detecting at least one litter object, if at least one of the detected one or more objects is classified in the litter object category; and generating a control signal to an elevator processing system for generating a service need request in response to detecting the at least one litter object.

The method may further comprise: receiving the control signal, wherein the control signal may comprise litter quantity data representing the number of the detected litter objects; obtaining predefined cleanness level data representing a required level of cleanness of the elevator car; and generating the service need request based on the predefined cleanness level data and the litter quantity data.

The generating the service need request may comprise generating an immediate service need if the litter quantity data meets a predefined threshold level comprised in the predefined cleanness level data, or otherwise generating a standard service need.

The litter object category may further comprise one or more subcategories for different types of litter objects, wherein the method may further comprise classifying the detected at least one litter object into the one or more subcategories based on the predefined litter object definition data.

The one or more objects may be detected from the optical image data by using at least one pre-trained neural network model.

The optical image data may be obtained from at least one imaging device arranged inside the elevator car.

The service need request may be generated to an elevator service center and/or to a cleaning service center.

According to a second aspect, an elevator car litter detection system is provided, wherein the elevator car litter detection system comprises: at least one optical imaging device arranged inside an elevator car and configured to capture optical image data of interior of the elevator car; an elevator processing system; and a litter recognition unit configured to: obtain the optical image data of the interior of the elevator car captured by the at least one optical imaging device, detect one or more objects from the optical image data; classify the detected one or more objects into predefined object categories based on predefined litter object definition data, wherein the predefined object categories comprise a litter object category and at least one other object category; detect at least one litter object, if at least one of the detected one or more objects is classified in the litter object category; and generate a control signal to the elevator processing system for generating a service need request in response to detecting the at least one litter object.

The elevator processing system may further be configured to: receive the control signal from the litter recognition unit, wherein the control signal may comprise litter quantity data representing the number of the detected litter objects; obtain predefined cleanness level data representing a required level of cleanness of the elevator car; and generate the service need request based on the predefined cleanness level data and the litter quantity data.

The generation of the service need request may comprise that the elevator processing system is configured to generate an immediate service need if the litter quantity data meets a predefined threshold level comprised in the predefined cleanness level data, or otherwise to generate a standard service need.

The litter object category may further comprise one or more subcategories for different types of litter objects, wherein the litter recognition unit may further be configured to classify the detected at least one litter object into the one or more subcategories based on the predefined litter object definition data.

The litter recognition unit may be configured to detect the one or more objects from the optical image data by using at least one pre-trained neural network model.

The service need request may be generated to an elevator service center and/or to a cleaning service center.

According to a third aspect, an elevator system is provided, wherein the elevator system comprises: at least one elevator car arranged to travel along a respective elevator shaft, and an elevator car litter detection system as described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system.

FIG. 2A illustrates schematically an example of an elevator car litter detection system.

FIG. 2B illustrates schematically an example of an elevator processing system.

FIG. 3 illustrates schematically an example of a method for detecting at least one litter object inside an elevator car.

FIG. 4 illustrates schematically an example of a service need level evaluation process.

FIG. 5 illustrates schematically an example of components of a litter recognition unit.

FIG. 6 illustrates schematically an example of components of an edge processing unit of an elevator processing system.

### DESCRIPTION OF THE EXEMPLIFYING EMBODIMENTS

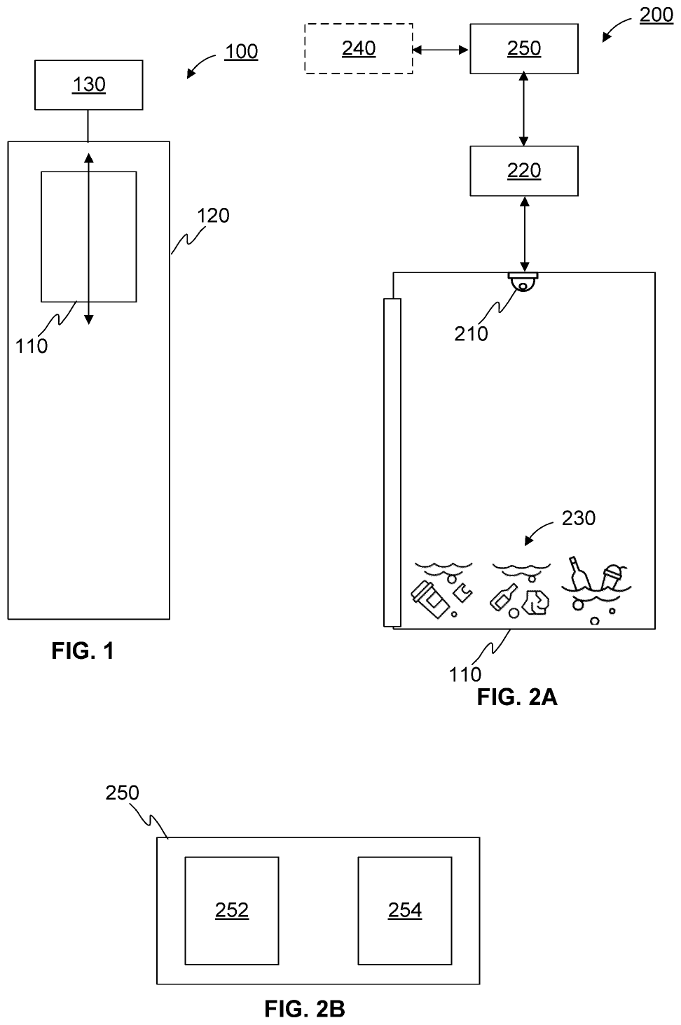

FIG. 1 illustrates schematically an example of an elevator system 100. The elevator system 100 comprises at least one elevator car 110 configured to travel along a respective elevator shaft 120 between a plurality of landings. The elevator system 100 of the example of FIG. 1 comprises one elevator car 110 travelling along one elevator shaft 120, however the elevator system 100 may also comprise an elevator group, i.e. group of two or more elevator cars 110 each travelling along a separate elevator shaft 120 configured to operate as a unit serving the same landings (for sake of clarity the plurality of landings are not illustrated in FIG. 1). The elevator system 100 further comprises an elevator control unit, e.g. an elevator controller, 130. The elevator control unit 130 may be configured to control the operation of the elevator system 100 at least in part. The elevator control unit 130 may reside e.g. in a machine room (for sake of clarity not shown in FIG. 1) or in one of the landings of the elevator system 100. The elevator system 100 may further comprise one or more other known elevator related entities, e.g. hoisting system, user interface devices, safety circuit and devices, elevator door system, etc., which are not shown in FIG. 1 for sake of clarity. The elevator system 100 further comprises an elevator car litter detection system 200 (for sake of clarity entities of the elevator car litter detection system 200 are not shown in FIG. 1).

FIG. 2A illustrates schematically an example of the elevator car litter detection system 200 for detecting at least one litter object 230 inside an elevator car 110. The elevator car litter detection system 200 comprises at least one optical imaging device 210, a litter recognition unit 220, and an elevator processing system 250. The at least one optical imaging device 210 is communicatively coupled to the litter recognition unit 220. The communication between the at least one optical imaging device 210 and the litter recognition unit 220 may be based on one or more known communication technologies, either wired or wireless. The litter recognition unit 220 is communicatively coupled to the elevator processing system 250. The communication between the litter recognition unit 220 and the elevator processing system 250 may be based on one or more known communication technologies, either wired or wireless. The elevator car litter detection system 200 may further comprise at least one service center 240. Alternatively, the elevator processing system 250 may be associated with the at least one service center 240. The at least one service center 240 may for example comprise an elevator service center and/or to a cleaning service center. The elevator processing system 250 is communicatively coupled to the at least one service center 240. The communication between the elevator processing system 250 and the at least one service center 240 may be based on one or more known communication technologies, either wired or wireless.

The at least one optical imaging device 210 is arranged inside the elevator car 110 and configured to capture optical image data of interior of the elevator car 110. The optical image data provided by the at least one optical imaging device 210 may comprise one or more images and/or video image comprising a plurality of consecutive images, i.e. frames. Preferably, the elevator car litter detection system 200 may comprise one optical imaging device 210 arranged inside the elevator car 110. However, more than one optical imaging device 210 may be used to achieve better coverage of the elevator car 110 with the optical image data, which improves the accuracy and reliability of the detection of at least one litter object inside an elevator car. The at least one optical imaging device 210 may be arranged (e.g. placed) at different placements inside the elevator car 110. Some non-limiting example placements of the at least one optical imaging device 210 may comprise: a middle placement (e.g. at least one optical imaging device 210 may be placed in the middle placement), a corner placement (e.g. at least one optical imaging device 210 may be placed in the corner placement), and a ceiling placement (e.g. at least one optical imaging device 210 may be placed in the ceiling placement). For example, the middle placement may be at the middle of a back wall of the elevator car 110 in a horizontal direction as illustrated in the example of FIG. 2A. Alternatively, the middle placement may be at the middle of any other wall of the elevator car 110 in the horizontal direction. For example, the corner placement may be at an upper back corner of the elevator car 110. The upper back corner of the elevator car 110 may be either one the upper back corners of the elevator car 110. Alternatively, the corner placement may be at an upper front corner of the elevator car 110. The upper front corner of the elevator car 110 may be either one the upper front corners of the elevator car 110. In FIG. 2A a non-limiting example location for the at least one optical imaging device 210 inside the elevator car 110 is illustrated. As also illustrated in the example of FIG. 2A, the at least one optical imaging device 210 may preferably be placed in a vicinity of a ceiling of the elevator car 110, i.e. as high as possible. The at least one optical imaging device 210 may be placed so that the optical image data provided by the at least one optical imaging device 210 covers as maximum area of the elevator car 110 as possible. Preferably, the at least one optical imaging device 210 may be placed so that the optical image data provided by the imaging device 210 covers at least a floor of the elevator car 110 completely. The at least one optical imaging device 210 may for example comprise a camera, e.g. a Red-Green-Blue (RGB) camera or a black-and-white camera. Preferably, at least one optical imaging device 210 may be capable of providing the optical image data with high resolution and/or a wide Field of View (FOV) to cover the maximum area of the elevator car 110 by the optical image data. The elevator car litter detection system 200 may also be configured to detect the at least one litter object 230 inside one or more elevator cars 110 of the elevator system 100. In that case at least one optical imaging device 210 may be arranged inside each elevator car 110 for capturing optical image data of interior of said elevator car 110.

The litter recognition unit 220 may be arranged to any on-site location in the elevator system 100 or any off-site location being remote to the elevator system 100 (e.g. the litter recognition unit 220 may be implemented as a remote computing unit, a cloud-based computing unit, or any other off-site computing unit). The elevator processing system 250 may comprise an edge processing unit 252 and a service need engine 254. FIG. 2B illustrates an example of the entities of the elevator processing system 250. The edge processing unit 252 is an additional processing and connectivity unit of the elevator system 100. The edge processing unit 252 may have a contact to the elevator control unit 130 (e.g. thought a bus) for obtaining elevator system related data. Alternatively or in addition, the edge processing unit 252 may comprise one or more sensor devices (internal and/or external sensor devices) for obtaining the elevator system related data. According to an example, the edge processing unit 252 may be arranged to the elevator car 110 (e.g. on a rooftop of the elevator car 110 or to any other location in the elevator car 110, either inside the elevator car 110 or outside the elevator car 110) or to any other on-site location in the elevator system 100. The service need engine 254 is responsible for generating service needs to the at least one service center 240. The service need engine 254 may be arranged at an off-site location being remote to the elevator system 100. For example, the service need engine 254 may be implemented as a cloud-based service need engine (i.e. the service need engine 254 is located in a cloud). According to an example, the litter recognition unit 220 may be integrated into the edge processing unit 252 of the elevator processing system 250. In other words, the operations of the litter recognition unit 220 may be implemented in the edge processing unit 252 of the elevator processing system 250

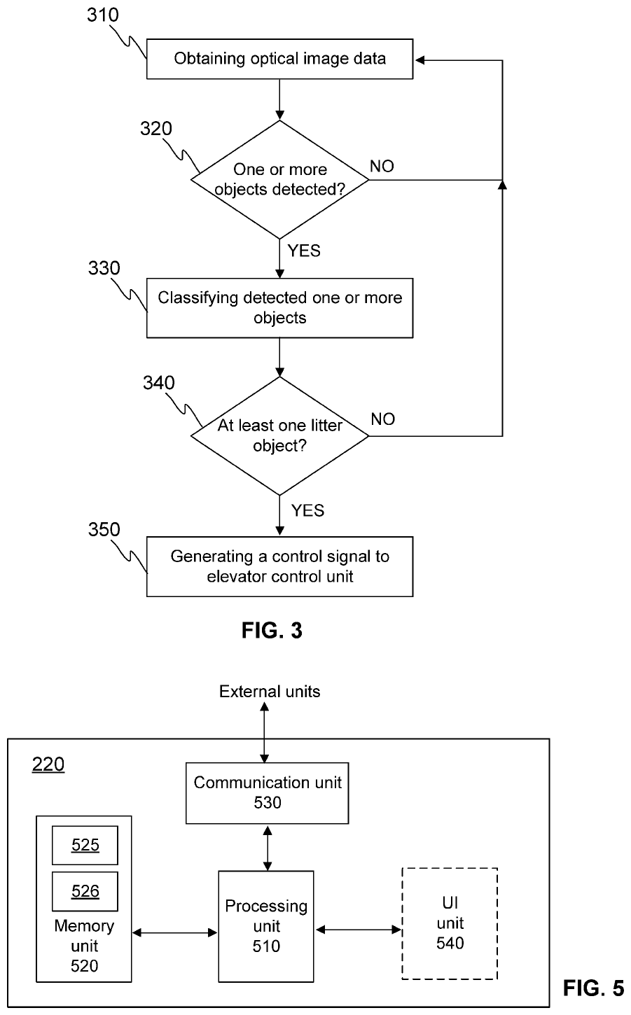

Next an example of a method for detecting at least one litter object 230 inside an elevator car 110 is described by referring to FIG. 3. FIG. 3 schematically illustrates the method as a flow chart. The example method of FIG. 3 is described by using only one elevator car 110, but the method may also be applied correspondingly for detecting the at least one litter object 230 inside more than one elevator cars 110.

At a step 310, the litter recognition unit 220 obtains optical image data of the interior of the elevator car 110 captured by the at least one optical imaging device 210. In other words, the litter recognition unit 220 obtains the optical imaging data of the interior of the elevator car 110 from the at least one optical imaging device 210. The litter recognition unit 220 may obtain the optical image data of the interior of the elevator car 110 constantly, periodically, or at certain point of times. Alternatively or in addition, the litter recognition unit 220 may obtain the optical image data of the interior of the elevator car 110 on request, i.e. the litter recognition unit 220 may for example generate a request to the at least one optical imaging device 210 to provide the optical image data of the interior of the elevator car 110.

At a step 320, the litter recognition unit 220 detects (i.e. extracts or recognizes) one or more objects from the optical image data. The litter recognition unit 220 is capable of recognizing any kind of objects. Therefore, the one or more objects detected by the litter recognition unit 220 may comprise any kind of objects, e.g. litter object(s) 230 and/or non-litter object(s). The litter recognition unit 220 may use at least one pre-trained neural network model 526 to detect the one or more objects from the optical image data. The at least one pre-trained neural network model 526 may for example comprise a single shot multibox detector (SSD) with a VGG16 convolutional neural network model.

At a step 330, in response to detecting the one or more objects at the step 320, the litter recognition unit 220 classifies the detected one or more objects into predefined object categories based on predefined litter object definition data. The predefined object categories comprise a litter object category and at least one other object category. The predefined litter object definition data may comprise definitions of one or more predefined litter objects, i.e. one or more predefined objects that are defined as litter objects 230. The predefined litter object definition data may be stored in a memory part 520 of the litter recognition unit 220. Alternatively or in addition, the predefined litter object definition data may be stored in a database from which the litter recognition unit 220 obtains the predefined litter object definition data. The predefined litter object definition data may be customer specific. In other words, the one or more objects that are defines as litter objects 230, may be customer specific. This enables that each customer may individually define which object(s) are defined as litter object. For example, some objects that are defined as litter objects 230 by one customer may not be considered as litter objects 230 for some other customer. Some non-limiting examples of the customer may comprise a hotel, a public transportation station (e.g. a metro station, a train station, a bus station, and/or an airport, etc.), and/or an office building, etc. According to a non-limiting example, in case the customer is a hotel, at least the following objects may for example be defined as litter objects 230: an empty can, a plastic bag, a plastic container, and/or a carboard box, etc. The litter recognition unit 220 classifies each of the detected one or more objects into the predefined object categories based on the predefined litter object definition data. Each object of the detected one or more objects that is defined as the litter object 230 based on the predefined litter object definition data is classified into the litter object category and each object of the detected one or more objects that is not defined as the litter object 230 based on the predefined litter object definition data is classified into the at least one other object category. The litter object category may further comprise one or more subcategories for different types of litter objects 230. The litter recognition unit 220 may further classify the detected at least one litter object 230 into the one or more subcategories based on the predefined litter object definition data. The litter recognition unit 220 may use the at least one pre-trained neural network model 526 to classify the detected one or more objects into predefined object categories. The pre-trained at least one neural network model 526 may for example be pre-trained by using images of litter objects 230 inside elevator cars 110 belonging to a plurality of different litter classes, for example but not limited to 30 different litter classes. The definitions of the one or more predefined litter objects 230, i.e. the one or more predefined objects that are defined as litter objects 230, comprised in the predefined litter object definition data may belong to these plurality of different classes used in the pre-training of the at least one neural network model 526.

At a step 340, the litter recognition unit 220 detects at least one litter object 230, if at least one of the detected one or more objects is classified in the litter object category at the step 330. In other words, if at least one of the detected one or more objects is classified in the litter object category, the litter recognition unit 220 infers that at least one litter objects 230 may be detected inside the elevator car 110.

At a step 350, the litter recognition unit 220 generates a control signal to the elevator processing system 250 for generating a service need request in response to detecting the at least one litter object 230 at the step 340. The control signal may for example comprise an indication of the detection of the at least one litter object 230 inside the elevator car 110 and/or an instruction to generate the service need request. The elevator processing system 250 may generate the service need request in response to receiving the control signal from the litter recognition unit 220. For example, the edge processing unit 252 of the elevator processing system 250 may receive the control signal from the litter recognition unit 220 and instruct the service need engine 254 of the elevator processing system 250 to generate the service need request. The service need request may be generated to the at least one service center 240, e.g. to the elevator service center and/or to the cleaning service center.

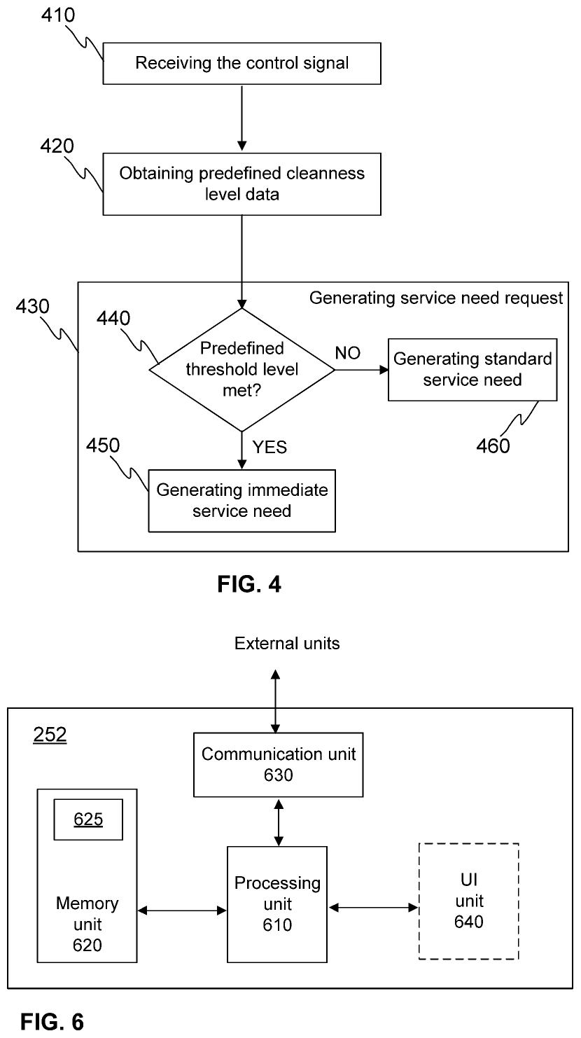

According to an example, the elevator processing system 250 may perform a service need level evaluation process in response to receiving the control signal from the litter recognition unit 220 before generating the service need request. An example of the service need level evaluation process is described by referring to FIG. 4. FIG. 4 schematically illustrates the service need level evaluation process as a flow chart.

At a step 410, the edge processing unit 252 of the elevator processing system 250 may receive the control signal from the litter recognition unit 220. It is described above that the control signal may comprise an indication of the detection of the at least one litter object 230 inside the elevator car 110 and/or an instruction to generate the service need request. Alternatively or in addition, the control signal may comprise litter quantity data representing the number of the detected litter objects 230.

At a step 420, the edge processing unit 252 of the elevator processing system 250 may obtain predefined cleanness level data representing a required level of cleanness of the elevator car 110. The edge processing unit 252 may for example obtain the predefined cleanness level data from a database. According to a non-limiting example the edge processing unit 252 may for example obtain the predefined cleanness level data from a database comprised in a cloud. The predefined cleanness level data may for example comprise a predefined threshold level representing the required level of cleanness of the elevator car 110. The predefined threshold level may for example be a number of detected litter objects 230. The cleanness level data may be predefined or configured by the customer. In other words, the customer may individually define the cleanness level required by said customer.

At a step 430, the elevator processing system 250 may generate the service need request based on the predefined cleanness level data and the litter quantity data. The generation of the service need request at the step 430 may comprise that the elevator processing system 250 generates an immediate service need at a step 450, if the litter quantity data meets the predefined threshold level comprised in the predefined cleanness level data at a step 440, or otherwise the elevator processing system 250 generates a standard service need at a step 460. In other words, the edge processing unit 252 compares at the step 440 the litter quantity data comprised in the control signal received from the litter recognition unit 220 to the predefined threshold level comprised in the predefined cleanness level data. If the litter quantity data (i.e. the number of the detected litter objects 230) meets the predefined threshold level, the edge processing unit 252 instructs the service need engine 254 to generate the immediate service need to the at least one service center 240 at the step 450. Alternatively, if the litter quantity data (i.e. the number of the detected litter objects 230) does not meet the predefined threshold level, the edge processing unit 252 instructs the service need engine 254 to generate the standard service need to the at least one service center 240 at the step 460. The immediate service need may comprise an instruction to immediately clean the elevator car 110. The standard service need may comprise an instruction to clean the elevator car 110 according to a scheduled cleaning, e.g. the next time when a cleaning person visits the elevator car 110. According to a non-limiting example, the predefined threshold level may be three detected litter objects 230, thus if the litter quantity data indicates that the number of the detected litter objects 230 is three or more, the edge processing unit 252 instructs the service need engine 254 to generate the immediate service need and if the litter quantity data indicates that the number of the detected litter objects 230 less than three, the edge processing unit 252 instructs the service need engine 254 to generate the standard service need.

The verb “meet” in context of a threshold level is used in this patent application to mean that a predefined condition is fulfilled. For example, the predefined condition may be that the predefined threshold level is reached and/or exceeded.

FIG. 5 illustrates schematically an example of components of the litter recognition unit 220. The litter recognition unit 220 may comprise a processing unit 510 comprising one or more processors, a memory unit 520 comprising one or more memories, a communication unit 530 comprising one or more communication devices, and possibly a user interface (UI) unit 540. The mentioned elements may be communicatively coupled to each other with e.g. an internal bus. The memory unit 520 may store and maintain portions of a computer program (code) 525, the at least one neural network model 526, the obtained optical image data, the predefined litter object definition data, and any other data. The computer program 525 may comprise instructions which, when the computer program 525 is executed by the processing unit 510 of the litter recognition unit 220 may cause the processing unit 510, and thus the litter recognition unit 220 to carry out desired tasks of the litter recognition unit 220, e.g. one or more of the method steps performed by the litter recognition unit 220 described above. The processing unit 510 may thus be arranged to access the memory unit 520 and retrieve and store any information therefrom and thereto. For sake of clarity, the processor herein refers to any unit suitable for processing information and control the operation of the litter recognition unit 220, among other tasks. The operations may also be implemented with a microcontroller solution with embedded software. Similarly, the memory unit 520 is not limited to a certain type of memory only, but any memory type suitable for storing the described pieces of information may be applied in the context of the present invention. The communication unit 530 provides one or more communication interfaces for communication with any other unit, e.g. the at least one optical imaging device 210, the elevator processing system 250, one or more databases, or with any other unit. The user interface unit 540 may comprise one or more input/output (I/O) devices, such as buttons, keyboard, touch screen, microphone, loudspeaker, display and so on, for receiving user input and outputting information. The computer program 525 may be a computer program product that may be comprised in a tangible nonvolatile (non-transitory) computer-readable medium bearing the computer program code 525 embodied therein for use with a computer, i.e. the litter recognition unit 220.

FIG. 6 illustrates schematically an example of components of the edge processing unit 252 of the elevator processing system 250. The edge processing unit 252 may comprise a processing unit 610 comprising one or more processors, a memory unit 620 comprising one or more memories, a communication unit 630 comprising one or more communication devices, and possibly a user interface (UI) unit 640. The mentioned elements may be communicatively coupled to each other with e.g. an internal bus. The memory unit 620 may store and maintain portions of a computer program (code) 625, the predefined cleanness level data, and any other data. The computer program 625 may comprise instructions which, when the computer program 625 is executed by the processing unit 610 of the edge processing unit 252 may cause the processing unit 610, and thus the edge processing unit 252 to carry out desired tasks of the edge processing unit 252, e.g. one or more of the method steps performed by the edge processing unit 252 described above. The processing unit 610 may thus be arranged to access the memory unit 620 and retrieve and store any information therefrom and thereto. For sake of clarity, the processor herein refers to any unit suitable for processing information and control the operation of the edge processing unit 252, among other tasks. The operations may also be implemented with a microcontroller solution with embedded software. Similarly, the memory unit 620 is not limited to a certain type of memory only, but any memory type suitable for storing the described pieces of information may be applied in the context of the present invention. The communication unit 630 provides one or more communication interfaces for communication with any other unit, e.g. the litter recognition unit 220, the service need engine 254, one or more databases, or with any other unit. The user interface unit 640 may comprise one or more input/output (I/O) devices, such as buttons, keyboard, touch screen, microphone, loudspeaker, display and so on, for receiving user input and outputting information. The computer program 625 may be a computer program product that may be comprised in a tangible nonvolatile (non-transitory) computer-readable medium bearing the computer program code 625 embodied therein for use with a computer, i.e. the edge processing unit 252.

The above discussed method and the elevator car litter detection system 200 improves monitoring the cleanness of elevator cars 110. The method and the elevator car litter detection system 200 enable automatization of the process of monitoring the cleanness of elevator cars 110. The method and the elevator car litter detection system 200 enable reducing cleaning costs of the elevator cars 110 by eliminating the need for visits by sanitation inspectors at the elevator site. Furthermore, the method and the elevator car litter detection system 200 enable the use of customer specific cleanness requirements in the litter detection as not all customers require the same level of cleanness of the elevator car 110.

The specific examples provided in the description given above should not be construed as limiting the applicability and/or the interpretation of the appended claims. Lists and groups of examples provided in the description given above are not exhaustive unless otherwise explicitly stated.

1. A method for detecting at least one litter object inside an elevator car, the method comprising the steps of:
obtaining optical image data of an interior of the elevator car;
detecting one or more objects from the optical image data;
classifying the detected one or more objects into predefined object categories based on predefined litter object definition data, wherein the predefined object categories comprise a litter object category and at least one other object category;
detecting the at least one litter object, if at least one of the detected one or more objects is classified in the litter object category; and
generating a control signal to an elevator processing system for generating a service need request in response to detecting the at least one litter object.

2. The method according to claim 1, further comprising the steps of:
receiving the control signal, wherein the control signal comprises litter quantity data representing a number of the detected litter objects;
obtaining predefined cleanness level data representing a required level of cleanness of the elevator car; and
generating the service need request based on the predefined cleanness level data and the litter quantity data.

3. The method according to claim 2, wherein the step of generating the service need request comprises generating an immediate service need if the litter quantity data meets a predefined threshold level comprised in the predefined cleanness level data, or otherwise generating a standard service need.

4. The method according to claim 1, wherein the litter object category further comprises one or more subcategories for different types of litter objects, wherein the method further comprises the step of classifying the detected at least one litter object into the one or more subcategories based on the predefined litter object definition data.

5. The method according to claim 1, wherein the one or more objects are detected from the optical image data by using at least one pre-trained neural network model.

6. The method according to claim 1, wherein the optical image data is obtained from at least one imaging device arranged inside the elevator car.

7. The method according to claim 1, wherein the service need request is generated to an elevator service center and/or to a cleaning service center.

8. An elevator car litter detection system, comprising:
at least one optical imaging device arranged inside an elevator car and configured to capture optical image data of an interior of the elevator car;
an elevator processing system; and
a litter recognition unit configured to:
obtain the optical image data of the interior of the elevator car captured by the at least one optical imaging device;
detect one or more objects from the optical image data;
classify the detected one or more objects into predefined object categories based on predefined litter object definition data, wherein the predefined object categories comprise a litter object category and at least one other object category;
detect at least one litter object, if at least one of the detected one or more objects is classified in the litter object category; and
generate a control signal to the elevator processing system for generating a service need request in response to detecting the at least one litter object.

9. The elevator car litter detection system according to claim 8, wherein the elevator processing system is further configured to:
receive the control signal from the litter recognition unit, wherein the control signal comprises litter quantity data representing a number of the detected litter objects;
obtain predefined cleanness level data representing a required level of cleanness of the elevator car; and
generate the service need request based on the predefined cleanness level data and the litter quantity data.

10. The elevator car litter detection system according to claim 9, wherein the generation of the service need request comprises that the elevator processing system is configured to generate an immediate service need if the litter quantity data meets a predefined threshold level comprised in the predefined cleanness level data, or otherwise to generate a standard service need.

11. The elevator car litter detection system according to claim 8, wherein the litter object category further comprises one or more subcategories for different types of litter objects, wherein the litter recognition unit is further configured to classify the detected at least one litter object into the one or more subcategories based on the predefined litter object definition data.

12. The elevator car litter detection system according to claim 8, wherein the litter recognition unit is configured to detect the one or more objects from the optical image data by using at least one pre-trained neural network model.

13. The elevator car litter detection system according to claim 8, wherein the service need request is generated to an elevator service center and/or to a cleaning service center.

14. An elevator system comprising:
at least one elevator car arranged to travel along a respective elevator shaft, and
the elevator car litter detection system according to claim 8.

15. The method according to claim 2, wherein the litter object category further comprises one or more subcategories for different types of litter objects, wherein the method further comprises the step of classifying the detected at least one litter object into the one or more subcategories based on the predefined litter object definition data.

16. The method according to claim 3, wherein the litter object category further comprises one or more subcategories for different types of litter objects, wherein the method further comprises the step of classifying the detected at least one litter object into the one or more subcategories based on the predefined litter object definition data.

17. The method according to claim 2, wherein the one or more objects are detected from the optical image data by using at least one pre-trained neural network model.

18. The method according to claim 3, wherein the one or more objects are detected from the optical image data by using at least one pre-trained neural network model.

19. The method according to claim 4, wherein the one or more objects are detected from the optical image data by using at least one pre-trained neural network model.

20. The method according to claim 2, wherein the optical image data is obtained from at least one imaging device arranged inside the elevator car.
